(19) United States
(12) Patent Application Publication
(10) Pub. No.: US 2015/0334929 A1
(43) Pub. Date: Nov. 26, 2015

(54) Self-Contained Aeroponic Growing Unit

(71) Applicant: Scott Miller, Brownstown, MI (US)

(72) Inventor: Scott Miller, Brownstown, MI (US)

(21) Appl. No.: 14/718,800

(22) Filed: May 21, 2015

Related U.S. Application Data
(60) Provisional application No. 62/001,723, filed on May 22, 2014.

(51) Int. Cl. A01G 31/02

(52) U.S. Cl. CPC A01G 31/02

(57) ABSTRACT

A self-contained aeroponic grow unit includes a reservoir FIG. 1 onto which is received a water manifold grid FIG. 11 and a plant holding lid FIG. 3 that receives a plurality of plant cuttings. The plant cuttings are received so the roots extend directly into the nutrient water held in the bottom third of the reservoir FIG. 1. A commercial grade water pump FIG. 5 and water manifold grid assembly FIG. 11 distributes nutrient solution through water spray jets FIG. 12 onto the net pot basket FIG. 29 that hold the plant cuttings, feeding the plant cuttings. The nutrient enriched water flows back into the reservoir for filtering and recirculation. The grow unit has four air stones FIG. 21 placed directly into the nutrient water, to create the oxygenated nutrient enriched zone.

### CROSS-REFERENCE TO RELATED APPLICATIONS

This application claims the benefit of U.S. Provisional Application No. 62/001,723, filed May 22, 2014, the contents of which are incorporated by reference herein.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

The present invention relates to plant husbandry in water culture also known to the technical field as aeroponics and fostering growth of plants in a nutrient environment and without soil. The basic principle of aeroponic growing is to grow plants suspended in a closed environment by spraying the plant's roots with an atomized or sprayed oxygenated nutrient enriched water solution. Existing applications for aeroponic growing lose water or nutrients through leakage and suffer root lock inhibiting growth. This invention is a self-contained aeroponic grow unit that holds the nutrient water within the unit and does not allow for leakage or loss of nutrients. The unique element of this invention is the roots grow directly into the oxygenated nutrient enriched water contained in the reservoir, therefore removing any possibility of root lock. Adding the deep water culture with the aeroponic application allows for maximum uptake of nutrients.

### Field of the Invention

An aeroponic system is an apparatus that provides a soilless water growing environment for plants.

### SUMMARY OF THE INVENTION

The invention described herein this application is an aeroponic grow unit that fosters growth of plants in a nutrient environment and without soil and provides for the development of full grown plants. This invention has removed the possibility of leakage, water or nutrient loss, root lock or spray jet clogging and are inherent issues with current aeroponic grow systems. The reservoir is located within the grow unit eliminating the potential for leakage or water or nutrient loss. There are no individual grow cells therefore the roots are allowed to grow directly into the reservoir removing any possibility of root lock. The water spray jets are positioned on each side of the net pot basket eliminating the possibility of roots clogging up the water spray jets allowing water to flow down the roots naturally back into the reservoir.

Air stones reside in the nutrient enriched water in reservoir keeping the water oxygenated. This creates an oxygenated nutrient enriched zone between the water and the plant holding lid and further encourages a healthier more productive yielding plant.

### BRIEF DESCRIPTION OF THE DRAWINGS

FIG. 1 Reservoir—100 gallon

FIG. 3 Plant holding lid

FIG. 4 Plant holding opening

FIG. 5 Commercial grade water pump

FIG. 6 Pump housing opening in the plant holding lid

FIG. 7 Hose assembly for water pump to filter

FIG. 8 Connector for the water manifold grid

FIG. 9 Hose assembly for Filter to Water manifold grid

FIG. 11 Water manifold grid—top view

FIG. 12 Water spray jets

FIG. 13 Water filter

FIG. 14 Water filter inlet opening in the plant holding lid

FIG. 15 Commercial grade PVC pump enclosure

FIG. 16 Water inlet opening in pump enclosure

FIG. 17 Air pump

FIG. 19 Air pump manifold

FIG. 21 Air stones

FIG. 23 Air stone hoses

FIG. 25 Timer

FIG. 27 Water level float indicator

FIG. 28 Water level float indicator opening

FIG. 29 Net pot basket

FIG. 31 Reservoir—side view

FIG. 33 Base unit—Reservoir with plant holding lid

FIG. 35 Plant holding lid on Base—top view

FIG. 37 Water manifold grid—bottom view

FIG. 39 Commercial grade pump inside commercial grade pump enclosure

FIG. 41 Net pot basket—top view

FIG. 43 Commercial grade water pump filter assembly

FIG. 45 Air stone air pump assembly

FIG. 47 Air stone hose route assembly

FIG. 51 Complete assembly

### SPECIFICATION

The present invention is a self-contained aeroponic plant growing unit, described in these documents, that holds the oxygen nutrient enriched water in the bottom third of the apparatus providing a constant source of nutrient enriched water and oxygenated nutrient enriched zone to the plant structure. The self-contained nature of the unit eliminates loss of water and nutrients. The oxygen nutrient enriched zone is further enhanced by the application of four air stones injecting oxygen directly to the nutrient enriched water, oxygenating the water. The oxygenated nutrient enriched water is applied in a 360 degree spray pattern, via the 360 degree water spray jets in the water manifold grid, on both sides of each root held in the slotted net pot basket at specifically timed intervals depending on the age of the plant and growth cycle via a standard timer. The root growth is contained through the net pot basket and within the bottom of the reservoir container allowing for free uninhibited growth. An inline filter is placed between the pump and the water filter inlet connection of the water manifold grid to eliminate any clogging or restriction of the water spray jets. The low pressure of the commercial grade water pump and water spray jets provide for low water temperature. The footprint of the unit coincides with the array of one artificial lighting unit. The low height of the unit provides for a larger growth area due to potential ceiling restrictions. A constant water level indicator is in place to identify maximum and minimum water levels. This system allows for growth of the plant to maturity.

### DETAILED DESCRIPTION OF THE INVENTION

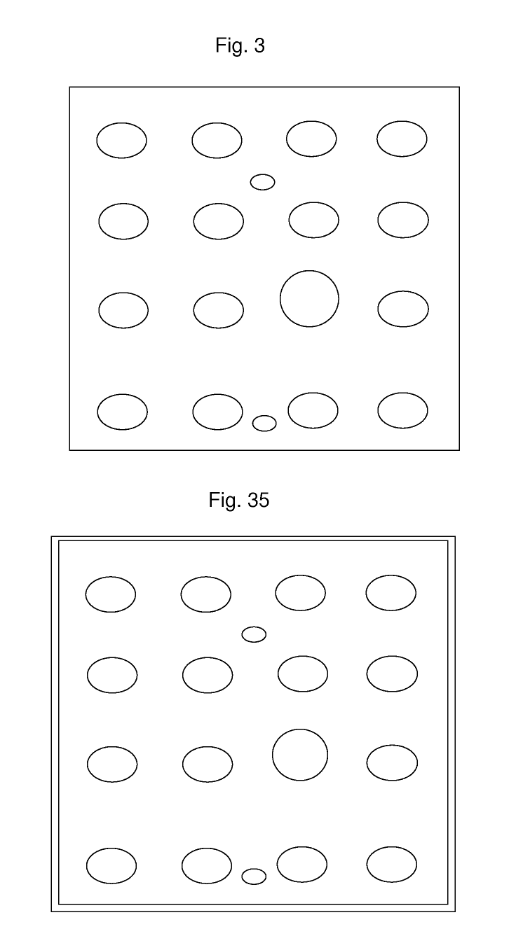

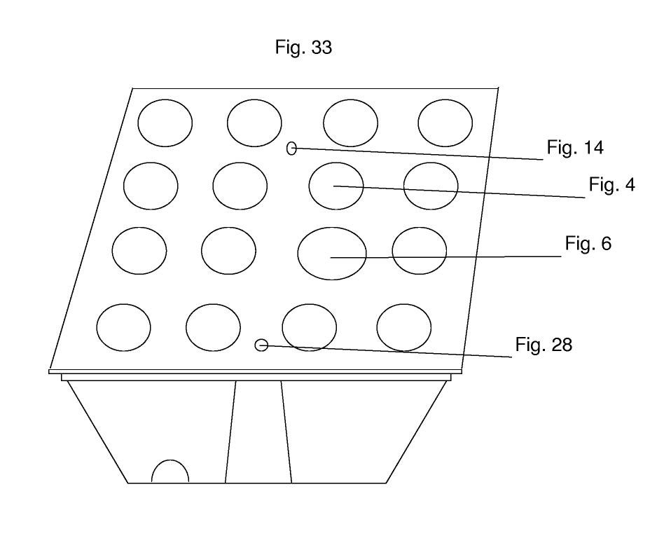

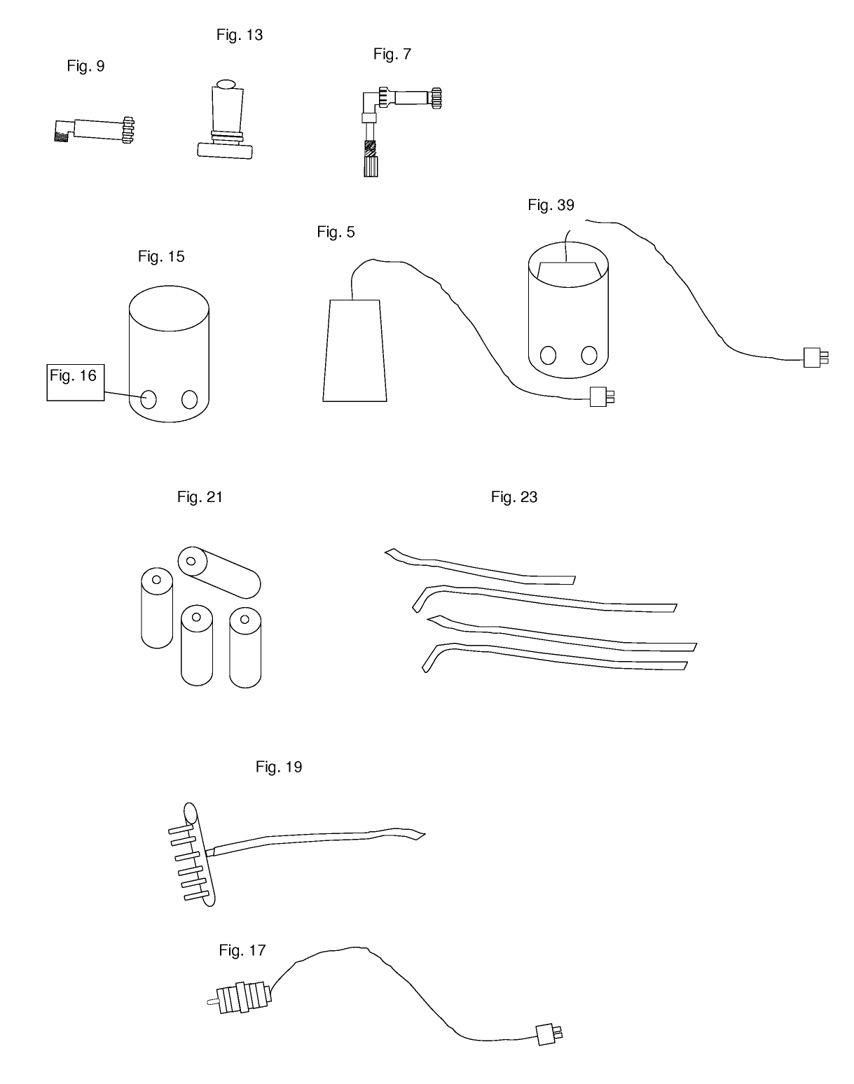

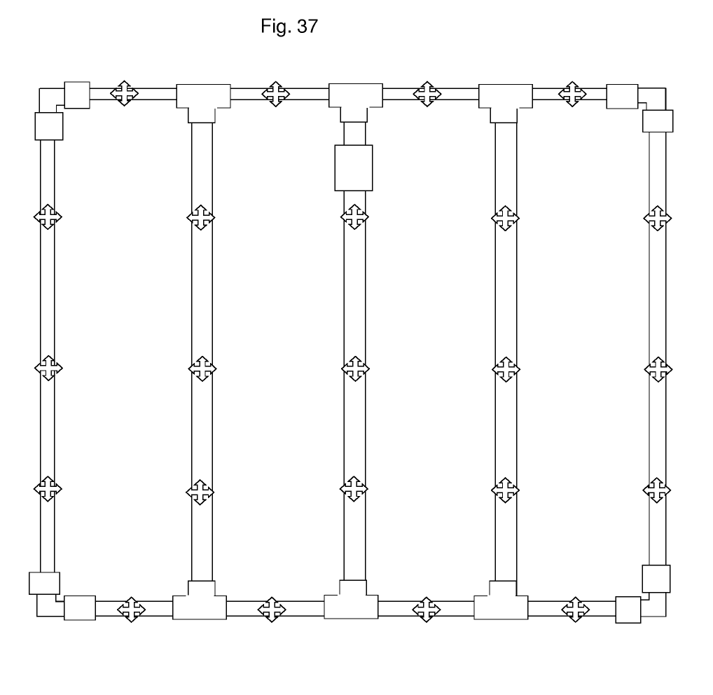

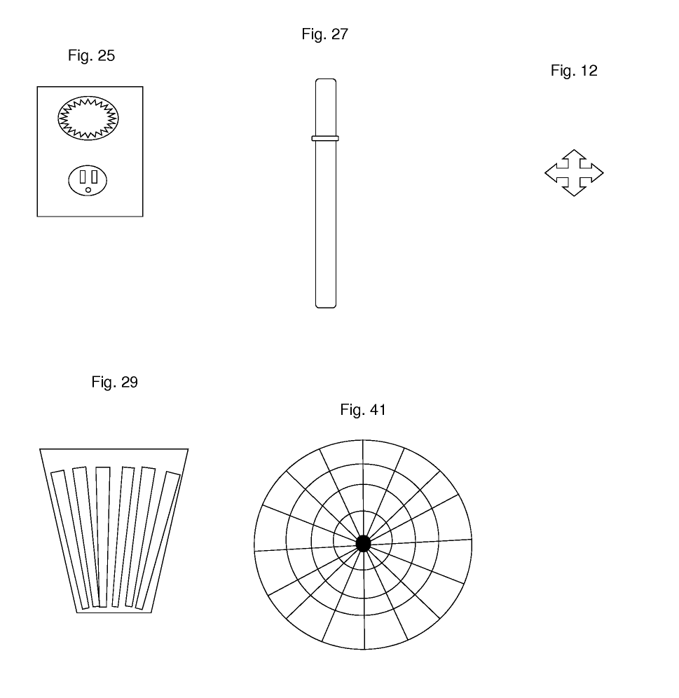

Referring now to the invention in the complete assembly FIG. 51 there is shown a self-contained aeroponic growing system that supplies water via the commercial grade water pump FIG. 5 and houses a water manifold grid FIG. 11 that delivers filtered nutrient oxygen enriched water through water spray jets FIG. 12 to the entire root system of the plant that are held by a net pot basket FIG. 29 in each plant holding opening FIG. 4 of the plant holding lid FIG. 3. The nutrient oxygen enriched water is circulated back through the system and filtered by the water filter FIG. 13. The commercial grade water pump FIG. 5 is activated through a timer FIG. 25 by which the frequency is determined by the growth cycle. Four air stones FIG. 21 provide for oxygen infusion into the nutrient enriched water. A water level float indicator FIG. 27 is utilized to monitor the maximum and minimum water required for the unit.

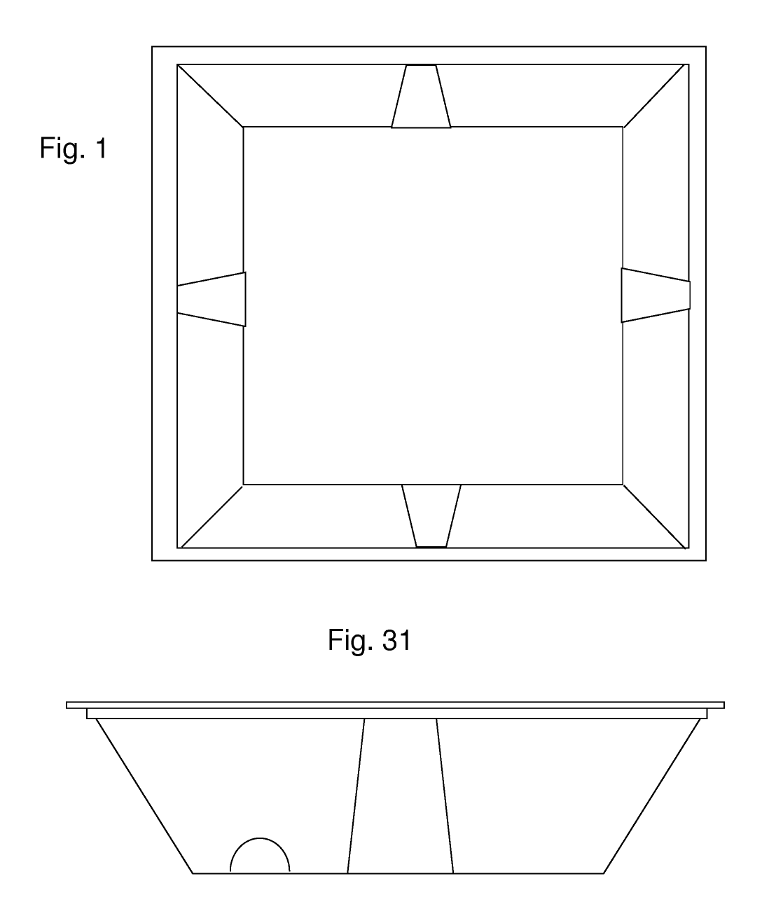

In more detail, still referring to the invention in the complete assembly FIG. 51 the self-contained aeroponic growing system is a highly efficient high yielding growth system due to the creation of the nutrient enriched oxygen zone, the 360 degree nutrient enriched water application, the self-contained feature that reduces the costs of nutrients significantly and the uninhibited root growth within the oxygenated nutrient enriched water reservoir. The 49.00×49.00 footprint FIG. 33 is applicable to the array of one lighting fixture. The 13 inch height FIG. 31 of the unit allows for full height growth for fifteen plants to maturity. The position of the water filter FIG. 13 to the output of the water spray jets FIG. 12 eliminates any potential for clogging of the water spray jets. The pump is a low pressure unit that does not heat the water therefore reducing evaporation of the nutrient enriched water. The open net pot basket FIG. 29 allows free range root growth through the net pot basket and directly into the water below. This removes any restriction to the root system eliminating any possibility of root lock. Four air stones FIG. 21 are ran continuously in the bottom of the water reservoir FIG. 1 to keep the nutrient enriched water highly oxygenated and healthy. A water level float indicator FIG. 27 is provided to monitor the water level and indicates maximum and minimum water levels.

It is important to note that by design of the described invention an oxygen enriched zone is created between the water manifold grid and the nutrient enriched water in the bottom of the reservoir. This is a critical component of the system as it aids in the health of the plant. This zone is enhanced and aided by the four air stones that are placed into the reservoir and constant power is provided to them keeping the nutrient enriched water healthy and oxygenated and enhancing the oxygen enriched zone.

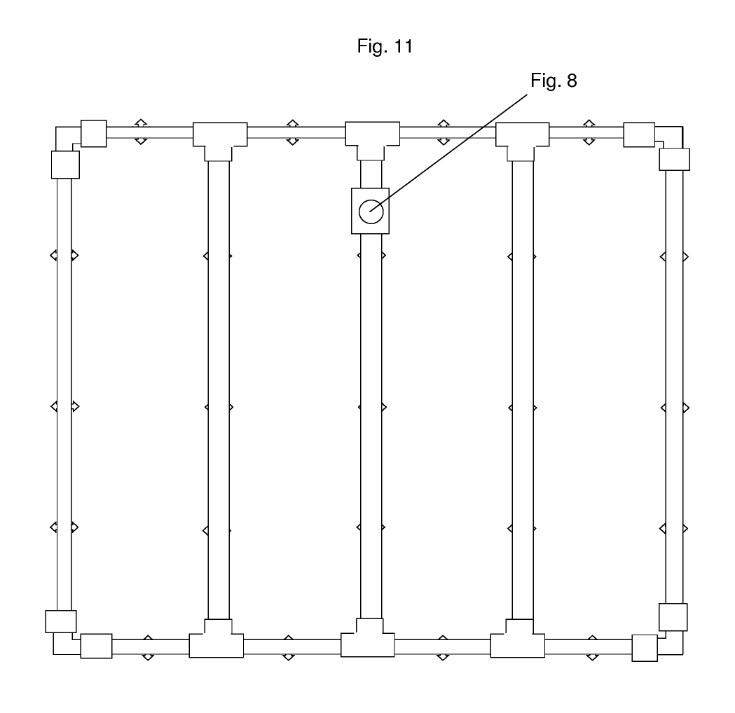

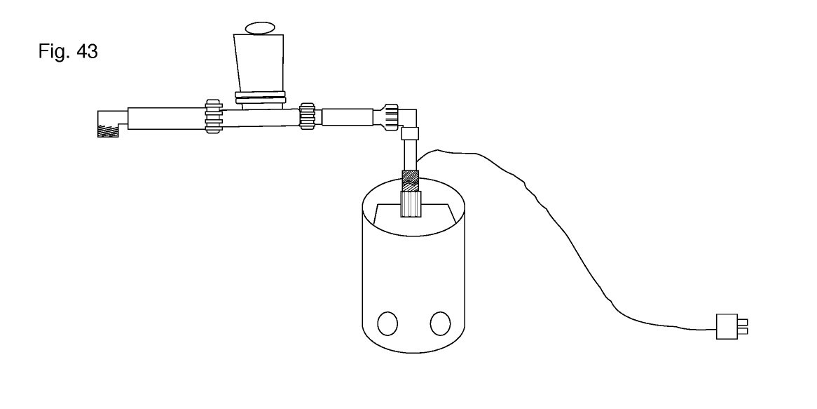

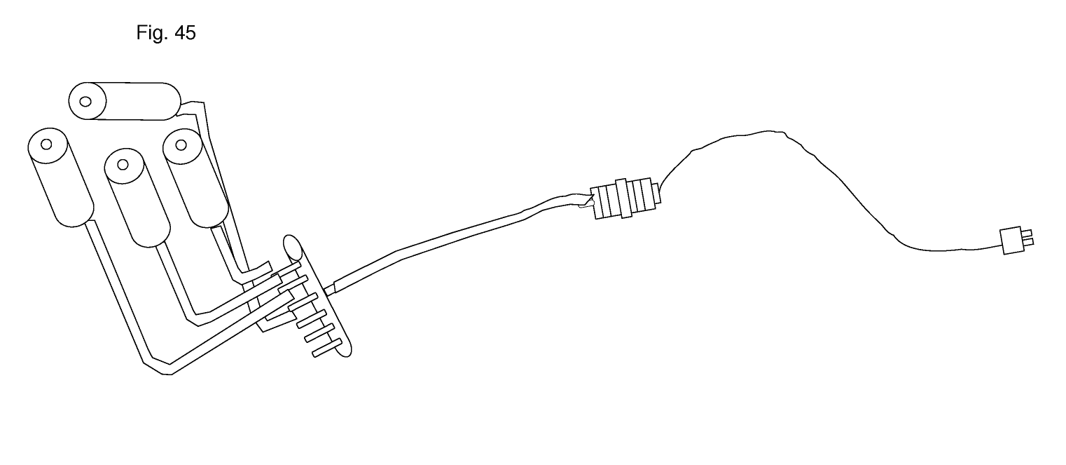

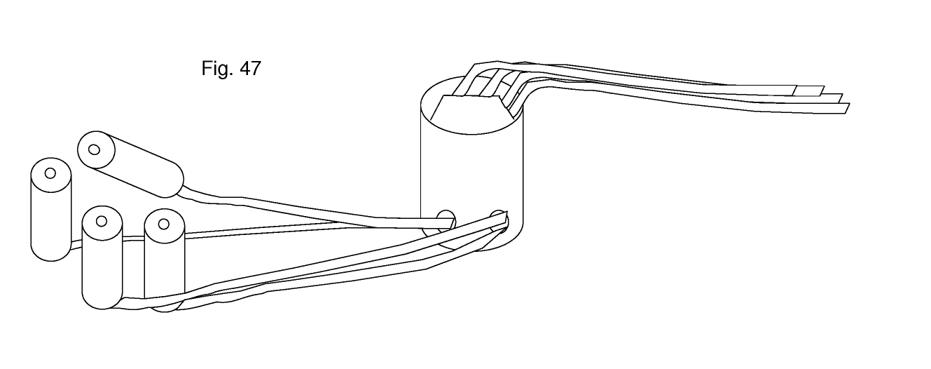

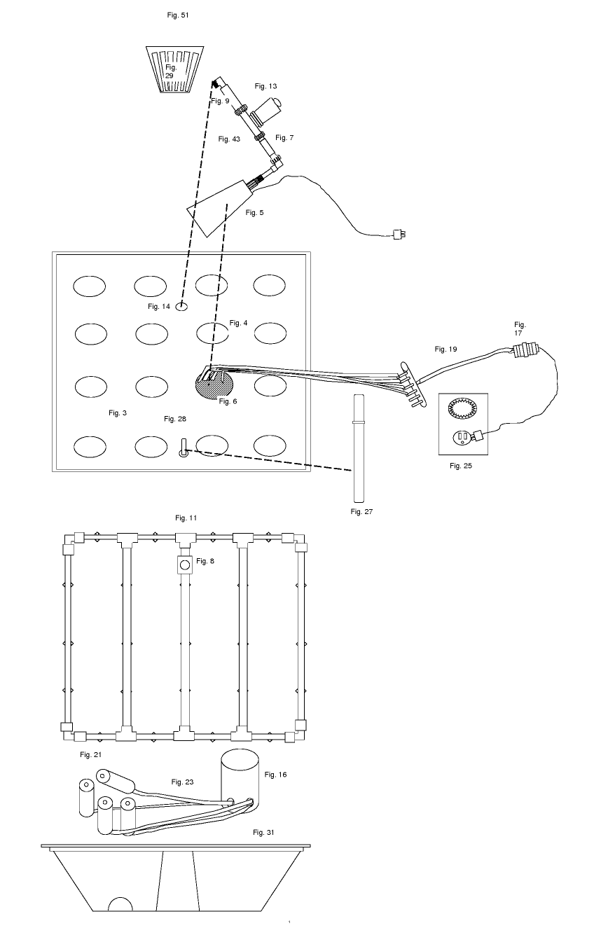

The construction details of the invention as shown in the complete assembly FIG. 51 is an overview of the self-contained aeroponic growing system. The reservoir FIG. 1 is made from 0.156 thick UV resistant ABS plastic reservoir that has an overall size of 49 inch×49 inch×13 inch. The reservoir has a 1 inch ridge on which the plant holding lid FIG. 35 sits. The body of the reservoir tapers to 40 inch×40 inch bottom allowing the water manifold grid FIG. 11 that measures 47 inch×47 inch to sit just below the plant holding lid securely. The four air stones FIG. 21 reside in the bottom of the reservoir with the air stone hoses FIG. 23 ran through the commercial grade PVC pump enclosure FIG. 15 outside of the reservoir and connected to the air pump manifold FIG. 18 that is attached directly to the air pump FIG. 17. The commercial grade PVC pump enclosure FIG. 15 being 8 inches in circumference and 10 inches tall is located in the pump housing opening in plant holding lid FIG. 6. The commercial grade PVC pump enclosure FIG. 15 holds the ⅙ horse power submersible utility 1350 gph—bottom feed pump commercial grade water pump FIG. 5 that circulates the nutrient enriched oxygenated water. There are four (4) 2 inch water inlet openings in the pump enclosure FIG. 16 to allow water to flow back into the commercial grade water pump FIG. 5. The water pump is connected to the water filter FIG. 13 by the hose assembly for water pump to filter, which is ¾ inch id×3 inch long with ¾ inch fittings, to filter FIG. 7 then the water filter FIG. 13 is connected to the water manifold grid FIG. 11 by the hose assembly for filter to water manifold grid, which is ¾ inch id×6 inch long with ¾ inch fittings, FIG. 9 via the water filter inlet connector for the water manifold grid FIG. 8. The assembly is illustrated in FIG. 43. The oxygenated nutrient rich water is then filtered through the water filter FIG. 11, which is a ¾ inch 125 micron filter, and back into the water manifold grid then is extruded through the water spray jets FIG. 12. The water spray jets have a 0.50 hole and a 360 degree spray. The nutrient enriched water is applied to each aide of each plant root system. The plant holding lid FIG. 3 has fifteen (15) 6 inch plant holding opening FIG. 4 and one 8 inch pump housing opening FIG. 6. The 8 inch pump opening FIG. 6 holds the 8 inch commercial grade PVC pump enclosure FIG. 15. The air stones are placed in the bottom of the reservoir with the air stone hoses FIG. 23 routed through the commercial grade pump enclosure. The pump enclosure is 10 inch in height allowing for greater stability of the pump. The pump is plugged into a standard timer FIG. 25 to apply the nutrient enriched water in specific intervals.

The plant holding lid FIG. 3 is 48 inches by 48 inches and is made from 0.07 thick UV resistant ABS plastic. The circumference of each plant holding opening FIG. 4 is 6 inches and one 8 inch hole for the pump enclosure (FIG. 6), spaced evenly throughout with 10 inch centers between plants. Each plant holding opening holds a 6 inch net pot basket FIG. 29 that allows the roots to grow freely and unrestricted through the net pot basket and directly into the nutrient rich reservoir.

The water manifold grid system FIG. 11 is constructed by the joining of five ½ inch PVC to eight ½ inch PVC forming the top and bottom sides of the grid. Each piece is attached by a “T” PVC connector and an elbow PVC connector on each corner forming a grid. A water filter inlet opening is created on the middle rung 4 inches from the top the by the use of a “T” PVC connector with the opening facing up and protrudes through the water filter inlet opening in the plant holding lid FIG. 14. The commercial grade water pump filter assembly FIG. 43 is attached from the commercial grade water pump to the hose assembly for water pump to filter FIG. 7 to the water filter FIG. 13 to the hose assembly for filter to water manifold grid FIG. 9. The water filter filters to 25 microns. FIG. 11 is the drawing showing the top view of the water manifold grid that sits under the plant holding lid. FIG. 37 is the bottom view of the water manifold grid system showing the placement of the 27 water spray jets FIG. 12 that supply the enriched nutrient water to each root system with 360 degree coverage.

The water level float indicator FIG. 27 is constructed by a 16 inch long 1 ⅝ inch id PVC tube and inserting a 1 ½ inch round smooth Styrofoam cylinder inside PVC tube. A black mark around the outside of the water level float indicator indicates maximum water level. When the top of the water level indicator becomes level with the top of the plant holding lid this would indicate that there is 3 inch water in the reservoir and has reached the minimum required and additional water should be added. This water level indicator fits snug through the 1 ¾ inch water level float indicator opening FIG. 28 in the plant holding lid and fluctuates up and down depending on the level of the water.

To summarize the complete assembly of the invention shown in FIG. 51, the four 4 inch round air stones are put in the bottom of the reservoir running the 3/16 inch by 5 ft. long air stone hoses FIG. 23 through the 2 inch water inlet holes in the commercial grade PVC pump enclosure FIG. 15. The air stone hoses FIG. 23 are connected outside of the reservoir to the air manifold FIG. 19 that is attached to the air pump FIG. 17. The commercial grade PVC pump enclosure, FIG. 15 is then placed in the reservoir and water manifold grid with the water spray jets FIG. 12 pointing down is inserted to sit around the top of the reservoir FIG. 1. The plant holding lid FIG. 3 is then placed on top of the water manifold grid FIG. 11 sitting on the lip of the reservoir. The commercial grade water pump FIG. 5 is placed within the commercial grade PVC pump enclosure FIG. 15 making sure to thread the air stone hoses FIG. 23 up around the commercial grade water pump and not allowing the pump to sit on the air stone hoses FIG. 23. The air stones FIG. 21 are attached to the air stone hoses FIG. 23 and sit in the bottom of the reservoir FIG. 1. The air stone hoses FIG. 23 are attached to the air pump FIG. 17 outside of the reservoir. The hose assembly for water pump to filter FIG. 7 is attached to the commercial grade water pump FIG. 5 and the other end to the water filter FIG. 13, making sure the water flow arrow is pointing to the Connector for the water manifold grid FIG. 8. The hose assembly for Filter to Water manifold grid FIG. 9 is attached to the other side of the water filter FIG. 13 and attached to the Connector for the water manifold grid FIG. 8. The water level float indicator FIG. 27 is placed into the water level float indicator opening FIG. 28. The commercial grade water pump FIG. 5 is plugged into the standard timer FIG. 25 that is plugged into the wall electrical outlet. The Air pump FIG. 17 is plugged into the wall electrical outlet. The net pot basket FIG. 29 are then inserted into each net plant holding opening FIG. 4 in the plant holding lid FIG. 3.

Referring now to the invention the advantages of the present invention include, without limitation, a self-contained growing unit providing oxygenation, nutrient application and eliminates root constriction or spray nozzle clogging. An oxygen nutrient rich zone is created. The placement of the spray nozzles along the top of the unit eliminates any possibility of the spray nozzles becoming clogged. The self contained feature reduces any loss of nutrients and contributing to the nutrient enriched oxygenated air zone.

Since certain changes may be made in the foregoing disclosure without departing from the scope of the invention herein involved, it is intended that all matter contained in the above description and depicted in the accompanying drawings shall be construed as illustrative and not in a limiting sense.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

Classification: 47/59, 47/62, 47/63

The invention claimed is:

1. aeroponic growing apparatus for growing plants comprising of:
A. a reservoir that holds the liquid nutrient solution to completely surround the plant roots;
B. a plant holding lid to receive plants above the root portions;
C. a water manifold grid to distribute the nutrient solution;
D. an air pump;
E. a water pump;
F. a timer controller;
G. a water filter;
H. and a water level indicator.

2. The apparatus of claim wherein the plant holding lid is divided into fifteen plant holding openings.

3. The apparatus of the claim creates an oxygenated nutrient enriched zone between the top of the water and the top of the plant holding lid.
